(19) United States
(12) Patent Application Publication
(10) Pub. No.: US 2008/0131029 A1
(43) Pub. Date: Jun. 5, 2008

(54) SYSTEMS AND METHODS FOR VISUALIZING AND MEASURING REAL WORLD 3-D SPATIAL DATA

(76) Inventors: Stanley E. Coleby, Holladay, UT (US); Brandon J. Baker, Salt Lake City, UT (US); Robert M. Vashisth, Salt Lake City, UT (US)

Correspondence Address: MADSON & AUSTIN, 15 WEST SOUTH TEMPLE, SUITE 900, SALT LAKE CITY, UT, 84101, US

(21) Appl. No.: 11/869,598

(22) Filed: Oct. 9, 2007

Related U.S. Application Data
(60) Provisional application No. 60/828,794, filed on Oct. 10, 2006.

(51) Int. Cl. G06K 9/54

(52) U.S. Cl. 382/300

(57) ABSTRACT

Systems and methods for viewing and measuring real world 3-D spatial data using corresponding image data and interpolation of low resolution 3-D spatial data is disclosed. Image data and 3-D spatial data are organized as a 3-D polygonal model. The resultant 3-D polygonal model may be viewed, measured or edited efficiently on a computer. The image data and 3-D data are aligned, and a point on the polygonal model may be measured. Additionally, low resolution 3-D spatial data and image data may be combined with high resolution and highly accurate 3-D spatial data and image data. The resultant combination of data sets may then be organized, aligned, viewed, measured or edited in an efficient manner on a computer.

### TECHNICAL FIELD

The present invention relates generally to systems and methods for visualizing and measuring data. More specifically, the present invention relates to systems and methods for visualizing and measuring real world 3-D spatial data.

### BACKGROUND OF THE INVENTION

3-D spatial data can be acquired using photogrammetric or light detection and ranging (LIDAR) systems and methods. Acquired 3-D spatial data, however, typically lacks the resolution required. Satellites can capture relatively high resolution images for large areas. Accurate 3-D spatial data, however, is not always as easy to attain at a high resolution. 3-D spatial data acquisition devices are not as efficient as imaging devices. High resolution images obtained from satellites or other means are often mapped to lower resolution 3-D spatial data acquired from, for example, land-based surveys or aerial scanners. However, systems and methods for efficiently viewing and measuring real world 3-D spatial data do not exist. Modern systems in the current state of the art are not organized in a way that they can be rendered or processed efficiently on computer graphics hardware or software systems. Consequently, systems and methods for efficiently visualizing and measuring real world 3-D spatial data are desirable.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 is an illustration of a possible set of 3-D spatial data and image data;

FIG. 2 is an illustration of the 3-D spatial data and image data similar to that of FIG. 1 with longitudinal and latitudinal components;

FIG. 3 is an illustration of a cross-section of a possible 3-D spatial data set;

FIG. 4 is an illustration of a cross-section of a another possible 3-D spatial data set;

FIG. 5 is a flowchart illustrating a possible embodiment of the present invention; and

FIG. 6 is a flowchart illustrating another exemplary embodiment of the present invention.

### DESCRIPTION OF THE INVENTION

The following description of several exemplary embodiments of the present invention, as disclosed below, is not intended to limit the scope of the invention, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments. Furthermore, as used herein the term “embodiment” or “embodiments” may refer to one or more different variations of the disclosed invention and does not necessarily refer to a single variation of the disclosed invention.

Many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

The term “determining” (and grammatical variants thereof) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The present invention uses data organization to efficiently render 3-D spatial data and interpolation to enhance the resolution of the 3-D spatial data to correspond with the higher resolution image data. Further, expensive and time-consuming data acquisition techniques can be minimized using the present invention. High resolution 3-D spatial data can be determined or estimated using image data and low resolution 3-D spatial data or 3-D spatial data for smaller areas.

The present invention includes image data and low 3-D spatial data or high resolution 3-D data for a smaller area to achieve or estimate high resolution 3-D spatial data. For the purpose of describing this invention, the 3-D spatial data could include or be determined using Geographical Information Systems (GIS) data, Light Detection and Ranging (LIDAR) data, Global Positioning System (GPS) data, Global Coordinate System (GCS) Data, or other spatial data.

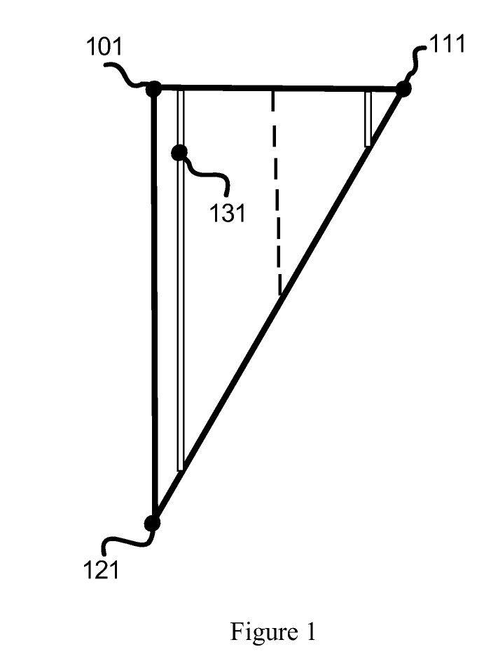

One possible embodiment of the present invention might include a first, a second, and a third 3-D spatial points 101, 111, 121, respectively, that can be connected to form a triangle superimposed over or associated with image data, as shown in FIG. 1. These points 101, 111, and 121 represent the 3-D spatial data points which correspond to vertices of the triangle.

The position of the 3-D spatial data points within a specified coordinate system may be determined in various ways. For example, the position of 3-D spatial data points may be “monuments” of known GCS position. Alternatively, the position of 3-D spatial data points within a global coordinate system may be determined using a GPS gathering device. Alternatively, image data aligned with LIDAR data may be utilized to determine the global position of data points within a scanned area using various techniques, such as U.S. Pat. No. 6,759,979 to Vashisth et al. and U.S. Pat. No. 6,664,529 to Pack et al., which are incorporated by this reference.

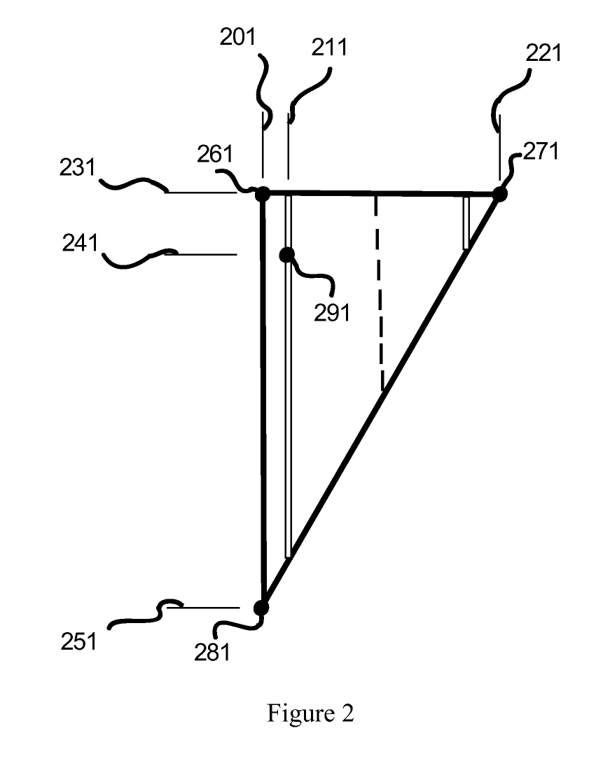

The divided highway shown in FIG. 1 shows the existing 3-D spatial data points at the vertices that can be used to interpolate the 3-D position of specific points on the image. A measured 3-D spatial data point 131 represents a point along one of the white stripes on the road. This measured point 131 is in between the 3-D spatial data points, and therefore there is no corresponding 3-D spatial data for that point in the image. The location of this point on the image, relative to the corners of the image can then be used to estimate the 3-D spatial coordinates of the measured point 131. An exemplary embodiment is explained using FIG. 2.

FIG. 2 is an illustration of the 3-D spatial data and image data similar to that of FIG. 1. The first 3-D spatial data point is labeled as part number 261; the second 3-D spatial data point is labeled as part number 271; the third 3-D spatial data point is labeled as part number 281; the measured point is labeled as part number 291. The component in the first dimension (longitude, or “x” direction) of the measured point is labeled as part number 211. The component in the second dimension (latitude, or “y” direction, for example) of the measured point is labeled as part number 241. The minimum and maximum components in the first dimension (longitude, or “x” direction) are labeled as part numbers 201 and 221, respectively. The minimum and maximum components in the second dimension (latitude, or “y” direction) are labeled as part numbers 251 and 231, respectively. The first 3-D spatial data point 261 is represented in the equation below as “A”; the second 3-D spatial data point 271 is represented as “B” in the equation; the third 3-D spatial data point 281 is represented as “C” in the equation.

FIG. 2 shows the relative position in the horizontal and vertical axes of the measured point 291 with respect to the vertices. The minimum and maximum components in the first dimension, 201 and 221 respectively, are assigned the values of zero (0.00) and one (1.00), respectively. The minimum and maximum components in the second dimension, 231 and 251, respectively, are also assigned the values of zero and one, respectively. The component in the first dimension of the measured point 211 is “E” in the equation below. The component of the measured point in the second dimension 241 is represented by “I” in the equation below. The values of the interpolated 3-D spatial data at the measured point 291, in “x, y, z” coordinates are represented as Dx, Dy, and Dz, the x, y, and z components, respectively. The same is true for Ax, which represents the x coordinate value of the first 3-D spatial data point 261, and is represented by “A” in the equation below; Cy, which represents the y coordinate value of the third 3-D spatial data point 281; Bz, which represents the z coordinate value of the second 3-D spatial data point 271, and so forth. The x, y, and z coordinates of the measured point 291 can thus be calculated according to the following equations:

Dx=(1−F)Ax+(F)Cx

Dy=(1−I)Ay+(I)Cy

Dz=(1−F)(1−I)Az+(F)(1−I)Bz+(I)Cz

Furthermore, a non-linear interpolation technique could be used, if desired. One example of a non-linear interpolation technique is the sinc method:

$$Cg ( x ) = {\sum }_{k = - ∞}^{∞} g ( kh ) sin c ( \frac{x - kh}{h} )$$

Cg(x) is the cardinal function (or Whittaker cardinal function), h is the sampling interval or period (the inverse of the sampling rate), k is the scaling factor for the interpolation points, x is the resulting domain variable (at the new, interpolated resolution), g is the input function (the existing 3-D spatial data points), and sinc is the common function used in signal processing and analytical mathematics:

$$sin c ( x ) = \frac{sin ( x )}{x}$$

The result of sinc interpolation is an arbitrarily high resolution of interpolated points between existing points. Thus, the existing 3-D spatial data can be used to generate as many intermediate points as necessary, equal to or greater than the resolution of the image data. One may benefit from having a higher resolution of 3-D spatial data than the image resolution because one could visually select a point on the image at a higher resolution than the image would yield, and attain high resolution 3-D spatial information about that point, even if no further image data were available. The sinc method described above also allows the edges of adjacent polygons to connect smoothly and may be more desirable in certain circumstances.

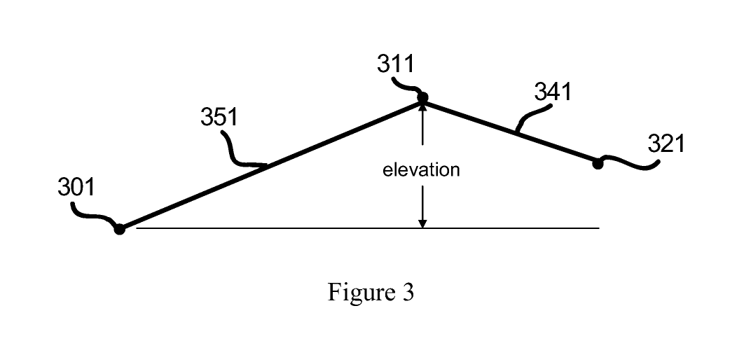

FIG. 3 illustrates a cross-section of a polygon created by a first 3-D spatial data point 301, a second 3-D spatial data point 311, and a third 3-D spatial data point 321. Linear interpolation produces an unnaturally rigid junction at the second 3-D spatial data point 311. The vertical slope of the terrain changes drastically from one side of the polygon, the first line representing the linear interpolated 3-D spatial data 341, to the second line representing the linear interpolated 3-D spatial data 351. When using 3-D spatial data to calculate terrain elevation contours, volumetric calculations, water run-off gradient, or other applications requiring the altitude of the data, the rigid junction at the second 3-D spatial data point 311 would not be desired.

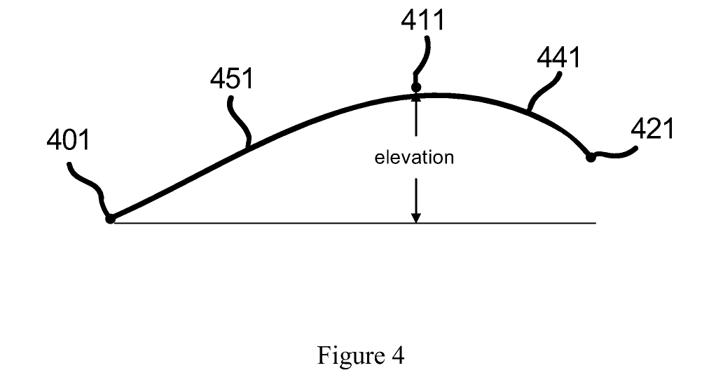

FIG. 4 illustrates a cross-section of a first 3-D spatial data point 401, a second 3-D spatial data point 411, and a third 3-D spatial data point 421. The second line 451, representing measured 3-D spatial data between the first 3-D spatial data point 401 and the second 3-D spatial data point 411, is a smooth surface when connected to the first line 441 representing measured 3-D spatial data at the second 3-D spatial data point 411. This creates a more natural and realistic effect than linear interpolation, in this instance.

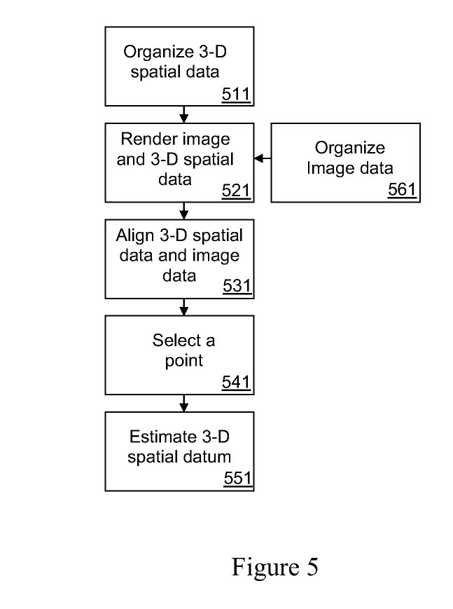

FIG. 5 shows a system illustrating one embodiment of the present invention. A few exemplary embodiments of measuring 3-D spatial data within the scope of the present invention have been illustrated; however, the component to determine the measured 3-D spatial data point 551 may be utilized by the following steps. For example, a user may click a button on a mouse while the cursor is at a certain position, as illustrated by the component to select a point within the data set 541. The point clicked may then be stored into memory based on the selected point on the scene that is being displayed to the screen, and seen by the user. The point on the scene (in screen coordinates, for example) may then be used to estimate the point (x, and y; or Latitude, Longitude, for example) on the scene by any variety of techniques, such as a ray tracing algorithm. The x and y points can then be related to neighboring points by means of a numerical interpolation technique such as a linear, cubic, quadratic, spline, sinc, or any other technique known to those skilled in the art. The illustrative embodiment shown herein is not the only way the present invention may be utilized. For example, the component to align 3-D spatial data to image data may be performed prior to rendering the data. Those skilled in the art may derive additional similar configurations without deviating from the scope of the present invention.

The component to organize the 3-D spatial data may be utilized to organize data into a structure that can be easily managed by existing 3-D computer graphics hardware and software. Some examples of such structures consist of, but are not limited to, triangle polygons, quads, nurbs, point sets, line sets, triangle sets, or other form. The 3-D spatial data may be in the form of a DEM, a DTM, a contour, a set of LIDAR scan data, or another form derived from photogrammetry or any other 3-D spatial data acquisition technique.

Image data may comprise an orthorectified image, a multi-spectral image, infrared (IR) spectral image, aerial photograph, elevation map, normal map, shadow map, digital photograph or other data that may be represented visually. One exemplary embodiment of the component to align the 3-D spatial data to the image data 531 may utilize an orthorectified image and a DEM. The alignment may be accomplished by selecting the points on the image and the 3-D spatial data and then calculating the proper alignment parameters (shift and rotation, for example) by a numerical optimization technique such as bisection method, Newton's method, linear least squares, recursive least squares, genetic algorithm, or other.

The corresponding image data are organized, as illustrated by the component to organize the image data 561. The image data are organized in a manner to be efficiently stored or rendered on graphics hardware and software systems, as shown by the component to render image and 3-D spatial data 521. Some exemplary embodiments of organization of image data may include sizing image data into horizontal and vertical dimensions each being a power of two in size, segmenting image data to smaller sections to efficiently fit in memory on graphics hardware, for example. Image data may be stored in compressed, uncompressed, indexed, or unindexed, or any variety of forms supported by said systems.

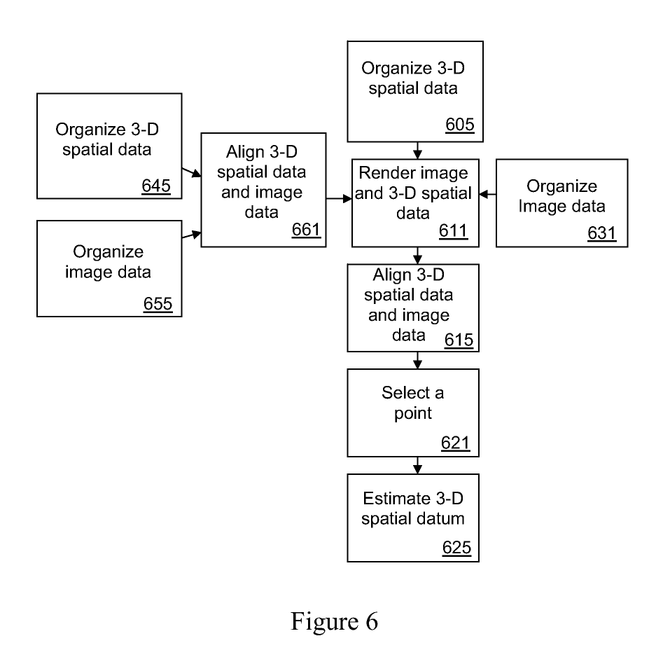

In certain circumstances, one may wish to acquire data from multiple sources and then combine data sets to simultaneously measure, visualize, or otherwise process, as shown in FIG. 6. In such a case, low resolution 3-D spatial data may be combined with high resolution and highly accurate 3-D spatial data. The high resolution and highly accurate 3-D spatial data may be acquired from a terrestrial LIDAR scanner, or other acquisition device. The high resolution and highly accurate 3-D spatial data may also be organized, as shown by the component to organize 3-D spatial data 645, fused, as shown by the component to align high resolution and highly accurate 3-D spatial data with image data 661. The corresponding image data have been organized, as shown by the component to organize 3-D spatial data 655, for better visualization. The organization of 3-D spatial data and image data is so that the data can be efficiently rendered or stored in computer graphics hardware or software, as described herein for the low resolution 3-D spatial data. Likewise, the low resolution 3-D spatial data may be organized, as shown by the component to organize low resolution 3-D spatial data 605. The corresponding image data have been organized, as shown by the component to organize corresponding image data 631. The data may be rendered as shown by the component to render image and 3-D spatial data 611. The low resolution 3-D spatial data and corresponding image data may be aligned, as shown by the component to align low resolution 3-D spatial data and corresponding image data 615. The alignment may occur prior to rendering the data, in an alternate exemplary embodiment. The user may select a point to be measured, as shown by the component to select a point 621, and the estimated 3-D spatial datum may be determined, as shown by the component to estimate 3-D spatial datum 625.

Also, it should be noted that the 3-D spatial data points may be determined by reference to any number of coordinate systems, such as a local coordinate system or a global coordinate system. The coordinate system could be a well-known and commonly used coordinate system or could be a single-use or proprietary coordinate system that may be used only for specific project.

Using the 3-D spatial data points of known or determined position, the image data is scaled and oriented. In other words, the image data may not be scaled to a proper size or may have become distorted for various reasons. The image data may be stretched or compressed to position corresponding portions of the image data over or at the correct location of the 3-D spatial data points, establishing a more accurate scale for the entire image. Thus, the image data will more accurately reflect the scale of the actual scene. Furthermore, the image data may not be properly oriented within the selected coordinate system. Positioning the corresponding portions of the image data directly on or at the 3-D spatial data points also orients the corresponding portions of the image data and thus the entire image data within the coordinate system.

Correlation between the image data and the 3-D spatial data points may be done in various ways. For example, manual correlation may be performed. One of the 3-D spatial data points could be the base of the flagpole or a fire hydrant, which is easily discernible in the image data, thus enabling manual scaling and orientation of the image data. Alternatively, automated or semi-automated techniques could be used for correlation between the 3-D spatial data points and the image data to enable automated or semi-automated orientation and scaling of the image data, which may also be used within the scope of the disclosed invention. Once the image data is properly scaled and oriented, distances between objects and sizes of objects shown on the image data are proportional to distances between and sizes of the real-world objects.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention. For example, the foregoing discussion uses a triangle is the reference polygon. Other polygons may be used, such as a rectangle. Also, the foregoing discussion relates to the estimation of points within the polygon. The same or similar techniques may be utilized to estimate the position of points outside the polygon. Of course, other “edge smoothing” techniques, beyond the sinc method, may be used within the scope of the invention. For example, an averaging or low-pass filtering technique could be used.

The disclosed invention may be utilized in various ways. For example, high-resolution 3-D scan data for a scene may be imported into or utilized with independently gathered image data. The high-resolution 3-D scan data can be utilized to determine reference points, which can be used as vertices for the polygon. Using the reference points, the independently gathered image data may be more accurately scaled and oriented, enabling interpolation of the position of other three-dimensional points. Using this technique, for example, a small area within a city or region may be scanned at a high 3-D resolution to determine 3-D reference points for vertices of the polygon. Thereafter, existing satellite images may be scaled and oriented using the 3-D reference points to enable interpolation of other 3-D points.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Functions such as executing, processing, performing, running, determining, notifying, sending, receiving, storing, requesting, and/or other functions may include performing the function using a web service. Web services may include software systems designed to support interoperable machine-to-machine interaction over a computer network, such as the Internet. Web services may include various protocols and standards that may be used to exchange data between applications or systems. For example, the web services may include messaging specifications, security specifications, reliable messaging specifications, transaction specifications, metadata specifications, XML specifications, management specifications, and/or business process specifications. Commonly used specifications like SOAP, WSDL, XML, and/or other specifications may be used.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described methods. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

1. A system for viewing and measuring 3-D spatial data using corresponding image data and interpolation of low resolution 3-D spatial data, comprising:
a processor;
memory in electronic communication with the processor; and
instructions stored in the memory, the instructions being executable to:
align image data and low resolution 3-D spatial data;
view 3-D spatial data and corresponding image data;
organize 3-D spatial data and corresponding image data as a 3-D polygonal model to be viewed, measured or edited in an efficient manner on a computer;
measure a point on the polygonal model consisting of 3-D spatial data and image data.

2. The system of claim 1 wherein organizing corresponding image data in an efficient manner comprises sizing image data into horizontal and vertical dimensions each being a power of two in size.

3. The system of claim 2, wherein sizing image data into horizontal and vertical dimensions each being a power of two in size comprises segmenting image data to smaller sections to efficiently fit in memory on graphics hardware.

4. The system of claim 1, wherein organizing 3-D spatial data comprises organizing vertex data as triangular polygon, quad, point list, line list, line strip, triangle list, triangle strip, triangle fan, or other form of 3-D graphics data known to those skilled in the art.

5. The system of claim 1, wherein aligning image data and low resolution 3-D spatial data comprises matching the points of image data to 3-D spatial data.

6. The system of claim 1, wherein measuring a point on the polygonal model comprises a ray tracing algorithm.

7. The system of claim 1, wherein measuring a point on the polygonal model comprises sinc, quadratic, cubic, spline, or other interpolation technique.

8. The system of claim 1, wherein 3-D spatial data comprises of a digital elevation model (DEM), a digital terrain model (DTM), contour data, aerial light detection and ranging (LIDAR) scan data, photogrammetric, or other.

9. The system of claim 1, wherein image data comprises an orthorectified image, multi-spectral image, IR spectral image, aerial photograph, elevation map, normal map, shadow map, or other data that may be represented visually.

10. A system for viewing and measuring multiple data sets of high resolution and highly accurate data with low resolution 3-D spatial data and image data, comprising:
a processor;
memory in electronic communication with the processor; and
instructions stored in the memory, the instructions being executable to:
align image data and 3-D spatial data;
view 3-D spatial data and corresponding image data;
organize 3-D spatial data and corresponding image data as a 3-D polygonal model to be viewed, measured or edited in an efficient manner on a computer; and,
measure a point on the polygonal model consisting of 3-D spatial data and image data.

11. The system of claim 10, wherein the high resolution, highly accurate 3-D spatial data comprises data acquired from a terrestrial LIDAR scanner.

12. The system of claim 10, wherein the high resolution, highly accurate 3-D spatial data comprises 3-D spatial data with corresponding image data.

13. The system of claim 10 wherein organizing corresponding image data in an efficient manner comprises sizing image data into horizontal and vertical dimensions each being a power of two in size.

14. The system of claim 13, wherein sizing image data into horizontal and vertical dimensions each being a power of two in size comprises segmenting image data to smaller sections to efficiently fit in memory on graphics hardware.

15. The system of claim 10, wherein organizing 3-D spatial data comprises organizing vertex data as triangular polygon, quad, point list, line list, line strip, triangle list, triangle strip, triangle fan, or other form of 3-D graphics data known to those skilled in the art.

16. The system of claim 10, wherein aligning image data and low resolution 3-D spatial data comprises matching the points of image data to 3-D spatial data.

17. The system of claim 10, wherein measuring a point on the polygonal model comprises a ray tracing algorithm.

18. The system of claim 10, wherein measuring a point on the polygonal model comprises sinc, quadratic, cubic, spline, or other interpolation technique.

19. The system of claim 10, wherein the low resolution 3-D spatial data comprises of a digital elevation model (DEM), a digital terrain model (DTM), contour data, aerial light detection and ranging (LIDAR) scan data, photogrammetric, or other.

20. The system of claim 10, wherein image data corresponding to low resolution 3-D spatial data comprises an orthorectified image, multi-spectral image, IR spectral image, aerial photograph, elevation map, normal map, shadow map, or other data that may be represented visually.
